(19) United States
(12) Patent Application Publication
(10) Pub. No.: US 2011/0307927 A1
(43) Pub. Date: Dec. 15, 2011

(54) METHOD, SYSTEM AND APPARATUS FOR MANAGING NETWORK SERVICES

(76) Inventors: Toshihisa Nakano, Osaka (JP); Masataka Minami, Hyogo (JP); Masayuki Kozuka, Osaka (JP); Yoshihiro Mori, Sherman Oaks, CA (US); James Mercs, Huntington Beach, CA (US); Mutsumi Kogawa, Glendale, CA (US)

(21) Appl. No.: 13/159,176

(22) Filed: Jun. 13, 2011

Related U.S. Application Data
(60) Provisional application No. 61/354,143, filed on Jun. 11, 2010.

(51) Int. Cl. H04N 5/445; H04N 7/173

(52) U.S. Cl. 725/61; 725/93

(57) ABSTRACT

The present invention may be an apparatus, method and/or system related to a playback device, playback media, and a network service utilizing retail information specifying where the playback media was purchased to allow development of media content that changes behavior based on certain conditions (e.g., a priority list based on the retail information specifying where the playback media was purchased), network service availability, and/or user selections. Accordingly, content providers may author or provide a single version of the playback media which may be sold to consumers via different retailers, while simultaneously providing business and/or advertising opportunities specific to the retailer that sold the particular media.

### CROSS-REFERENCE TO RELATED APPLICATION

This application claims priority from U.S. Provisional Application Ser. No. 61/354,143 filed on Jun. 11, 2010, the entire disclosure of which is incorporated herein by this specific reference.

### BACKGROUND OF THE INVENTION

1. Field of the Invention

The present invention relates to a method, system and apparatus which, among other advantages, allows retailers and/or content providers to leverage their content offering by incorporating their respective specific network services and content on media, e.g., Blu-ray. While the following description focuses on Blu-ray discs, the issues discussed are applicable to other forms of content distribution as well. Accordingly, the principles discussed herein should not be construed to be limited to Blu-ray media, players, etc.

2. Description of Related Art

Currently, when a consumer watches a movie on a Blu-ray disc, the consumer is typically shown a short series of advertisements or movie trailers prior to the main feature. The trailers, for example, pique the consumer's interest, such that he or she desires to watch or purchase the movie so advertised in the trailer. However, current media players do not allow the consumer to easily access or purchase that advertised movie via the same media player. As such, the consumer is left with the burden of remembering the title of the advertised movie and must make additional efforts to seek out and obtain the movie.

It should come as no surprise that many consumers ultimately do not purchase the advertised movie because the consumer, among many other reasons, forgets about the advertised movie, loses interest in seeking out the movie because the momentary thrill has passed or because he or she must expend additional effort to locate and purchase the movie, or is unable to obtain the advertised movie.

With the integration of the Internet and Blu-ray players, it is now technologically possible for the Blu-ray player to stream media from the Internet and provide the user the ability to obtain advertised products and/or services. However, such technological advancements have brought to light new challenges for retailers and studios. Retailers, for example, desire the ability to further advertise their products and thereby access a vast and untapped revenue stream—namely consumers who would have purchased the movie advertised in a trailer had the process been simplified and rendered more convenient, while ensuring that the consumer does not purchase the advertised movie from a competitor. To achieve this, retailers desire a system which allows the consumer to purchase the advertised product or service from the retailer immediately following or concurrent with the showing of an advertisement or a trailer. An unsophisticated approach may be to require a studio to produce a unique Blu-ray disc with unique advertising for each of the retailers selling the disc. However, the cost of such customization would be great, and if passed down to the consumer, would ultimately lead to a decline in sales. Instead, studios desire to retain the ability to produce one universal disc for all retailers to eliminate the costs of customizing the Blu-ray disc to each retailer.

Currently, it is not possible to share hardware and software resources such as showing the UI of an embedded application among a BD-J application and network service applications. It is also not possible to run another application (e.g., a web browser equipped on the Blu-ray player) while a BD-J application is running.

However, what is needed is an effective means or control for retailers and content providers to sell the related contents available on their network service during the Blu-ray playback off a universal disc.

### SUMMARY OF THE INVENTION

The present invention is an apparatus, method and/or system related to a playback device, playback media, and/or a network service. More specifically, the present invention develops media content by utilizing retail information specifying where the playback media was purchased, or by utilizing the identity of a media provider. In other words, the media content that is developed changes based on certain conditions (e.g., a priority list based on the retail information specifying where the playback media was purchased), network service availability, and/or user selections. By allowing the media content to be linked to the retail information, a single version of the playback media is needed for any number of different retailers, thus providing business and/or advertising opportunities specific to the retailer that sold the particular media. The description of the present invention may be described with relation to playback devices and playback media for ease of understanding. However, one of ordinary skill in the art will recognize that playback media may be replaced and/or include other media such as e-books, music, still pictures, e-magazines and the like, which are all within the scope of the invention.

In certain cases, if not most, playback of digital media may further be constrained by copyright protection, and the copyright protection is usually proprietarily tied to the specific service. However, should a “buy once, watch anywhere” service be established, a user may be able to purchase content from one retailer and play it on many playback devices in the same manner as contents purchased from other retailers (e.g., as the digital media is distributed via network, broadcast, etc.).

In one embodiment, playback media is in the form of a Blu-ray disc. The disc is read by the playback device to load a disc application and to obtain retail store information related to where the disc was purchased. The retail store information is then passed to a service management application to determine the network services corresponding to the retail store and supported by the playback device. The network services are then displayed to the user for selection. Upon user selection, the network service seamlessly presents playback media not stored on the disc to the user.

In one embodiment, a playback apparatus comprises a processor, a network controller, an I/O interface and a memory. The playback apparatus generally functions by reading content from a content provider (the content including playback media) to obtain a retail identification code. Based on the code, the playback apparatus determines a prioritized list of network services and transmits the prioritized list of the network services via the input/output interface to a display device for the user to view. The user is then able to select a network service from the prioritized list. Upon receiving the user selection, the playback apparatus then transmits a request for the content from a network service provider corresponding to the network service via the network controller, receives the requested content from the network service provider via the network controller, and accordingly transmits the received requested content to the display device for the viewing pleasure of the user.

In another embodiment, a playback system includes three main components: playback media, a playback apparatus, and network service providing servers. Here, the playback apparatus reads the playback media to playback the content, and to determine a priority ranking of the one or more network service capabilities based on the retail source of the playback media. The apparatus displays the ranked network services to the user and receives a selection from the user. In response, the network service providing server corresponding to the selected network service transmits playback content that is different than the playback content on the playback media to be played on the apparatus.

In yet another embodiment, the present invention is a non-transitory computer readable medium storing instructions that when executed by a processor, causes the processor to perform the method comprising: reading content from a content provider, the content including playback media and a retail identification code; determining a prioritized list of network services based on the retail identification code; transmitting the prioritized list of the network services to a display device; receiving a selection of a network service from the prioritized list from a user; transmitting a request for content from a network service provider corresponding to the network service; receiving the requested content from the network service provider; and transmitting the received requested content to the display device.

The above-described embodiments are merely a summary of the different embodiments of the present invention, and are not meant to be an exhaustive description of the different embodiments within the scope of the invention. However, certain embodiments are directed towards providing an advantageous system for providing additional sales opportunities for the retailer even after the retailer has sold the media with the playback content to the user. In this manner, the retailer is able to tap into a market long ignored due to the constraints of technology. Simultaneously, the user is provided an opportunity to easily and conveniently purchase products (e.g., movies, shows, etc.) during playback of different content. Whereas in the past where the user would have to remember the product, and after playback, go to the store to purchase the product wasting valuable time and energy, now the user may simply exercise an option to purchase immediately.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a block diagram of a system for providing content to a user including a display device, an input device, a playback device and one or more network services in accordance with one or more embodiments;

FIG. 2 is a block diagram of a Blu-ray system for providing content to a user including a Blu-ray disc, a Blu-ray player and one or more network services in accordance with one or more embodiments;

FIG. 3 is a flowchart of a method of operation in accordance with one or more embodiments;

FIG. 4 is a diagram of an implemented system for the performance of the method of operation of FIG. 3 in accordance with one or more embodiments;

FIG. 5 is a flowchart of a method of determining priority in accordance with one or more embodiments;

FIG. 6 is a chart of different network services in accordance with one or more embodiments;

FIG. 7 is a priority chart of network services for one or more retailers in accordance with one or more embodiments;

FIG. 8 is a resulting priority chart for a particular retailer in accordance with one or more embodiments;

FIG. 9 is an example of screen shots of network service selection screens in accordance with one or more embodiments;

FIG. 10 is an example of a screen shot of an instant-purchase process in accordance with one or more embodiments;

FIG. 11 is an example of screen shots of an instant-purchase process in accordance with one or more embodiments;

FIG. 12 is an example of a screen shot of an instant-purchase process in accordance with one or more embodiments;

FIG. 13 is a block diagram of a media distribution system for providing content to a user including various media sources and one or more network services in accordance with one or more embodiments; and

FIG. 14 is a diagram of an implementation of the playback device for providing content to a user in accordance with one or more embodiments.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which are included within the spirit and scope of the invention as defined by the appended claims. For example, as used herein, the term “retailer” may incorporate actual retail stores, but may also include e-commerce websites, network distribution services, individuals (independent content producer, individual distributor, etc.), and may be generally understood as any entity which sells or provides products (including content) or rights to content.

In certain circumstances, the network service providers may constitute a retailer. The term “network service” as used herein is intended to be broader than services provided by a network service provider and may include, for example, individuals who provide or sell content over a network (e.g., the Internet). Furthermore, in the following detailed description of the present invention, numerous specific details are set forth in order to provide a thorough understanding of the present invention. However, it will be obvious to one of ordinary skill in the art that the present invention can be practiced without these specific details. In other instances, well known methods, procedures, components, and circuits have not been described in detail as not to unnecessarily obscure aspects of the present invention.

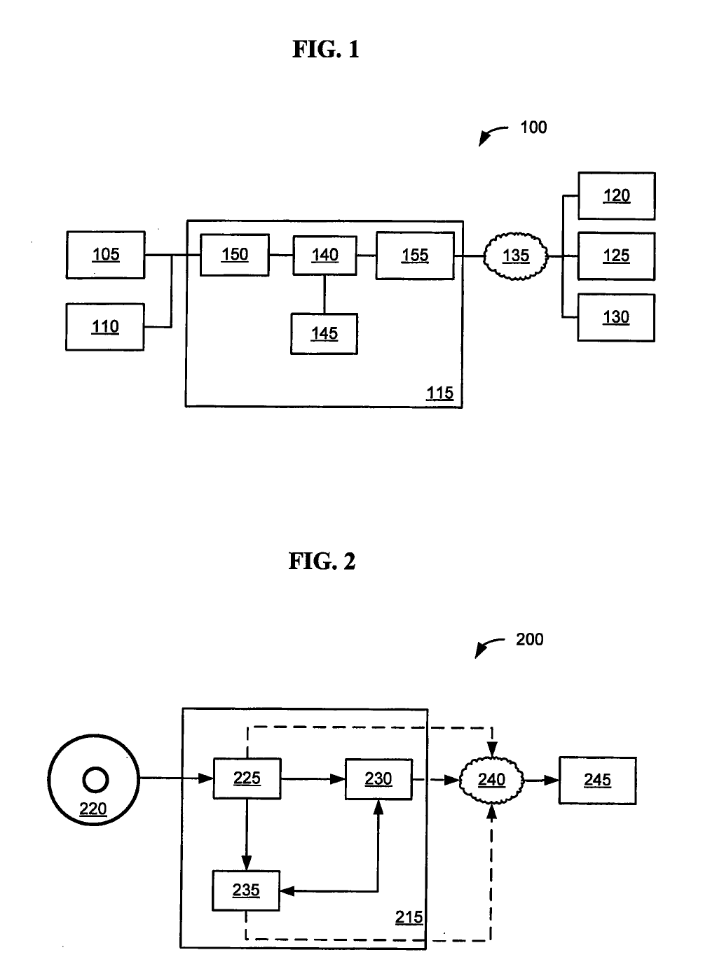

Referring to FIG. 1, a block diagram 100 of a system for providing content to a user includes a display device 105, an input device 110, a playback device 115 and network services 120, 125, 130 accessible via the Internet or a network 135 is shown. The display device 105 could be a television or display monitor such as a LED, LCD, plasma or cathode tube display device. The input device 110 includes devices like a remote control, a software remote control such as a soft keyboard, a physical keyboard, mouse or any other input device for controlling the display device 105 and/or the playback device 115. The playback device 115 is, for example, a Blu-ray player, a computer, a video game console, a mobile communication device or any other playback media player.

In one embodiment, the input device 110 and the display device 105 is integrated with the playback device 115. Alternatively, the input device 110, the display device 105 and the playback device 115 are separate devices communicating with each other wirelessly or via a cable. As shown, the playback device 115 includes a processor 140, a memory 145, an I/O interface 150 and a network controller 155. Here, the memory 145 is tangible and non-transitory. The memory 145 is configured to store instructions (e.g., executable code) that when executed by the processor 140, cause the playback device 115 to operate as discussed herein. Alternatively, some or all of the instructions may be embodied in hardware or firmware (not shown). The processor 140 is coupled to the I/O interface 150 to provide playback data to the I/O interface for output and to receive input from the user.

The processor 140 is further coupled to a network controller 155 for receiving data from network 135 which is, for example, a local area network (LAN) and/or a wide area network (WAN), but could also include other networks. When used in a LAN networking environment, the playback device 115 is connected to the LAN through a network interface or adapter (not shown). When used in a WAN networking environment, the playback device 115 could include a modem (not shown) or other means for establishing communications over the WAN, such as the network or Internet 135. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit the playback device 115 to retrieve data from a web-based server (e.g., housing network service 120, 125, 130).

In one embodiment, the present invention is operational with numerous other general purpose or special purpose computing system environments or configurations. Examples of well-known computing systems, environments, and/or configurations that are suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention is further describable in the general context of computer-executable instructions, such as program modules, being executed by a processor. Generally, program modules include routines, programs, objects, components, data structures, etc. that perform particular tasks or implement particular abstract data types. The invention could also be practiced in distributed computing environments where tasks are performed by remote processing devices that are linked through a communications network. In a distributed computing environment, program modules may be located in both local and remote computer storage media including memory storage devices.

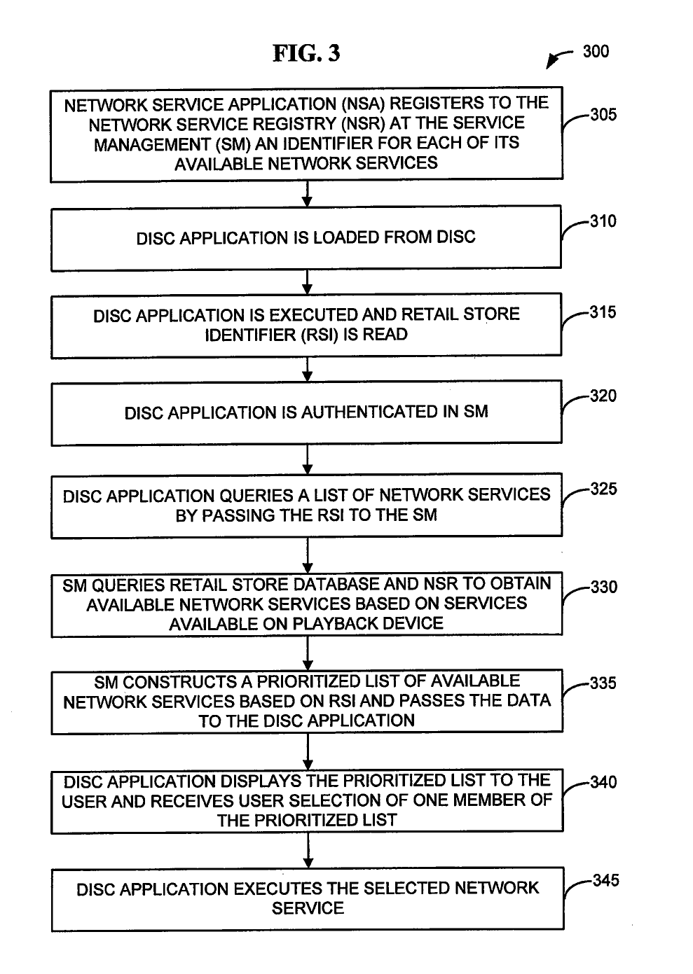

FIG. 2 illustrates one implementation of the present invention. As shown, the playback device 215 is a Blu-ray player configured to receive and read a Blu-ray disc 220. While this implementation describes a Blu-ray disc 220 for ease of understanding, other storage devices including external memory and/or internal (e.g., embedded) memory such as other physical discs, memory storage, high density drives, and the like may be used in conjunction or in place of the Blu-ray disc 220. The Blu-ray disc 220 is a storage disc holding media content (e.g., a movie, trailers, advertisements, etc.) as well as data indicating from which retail store it was purchased (e.g., a retail identification code) that the supplier of the Blu-ray disc 220 can trace to the particular retail source. The retail identification code is a unique identifier of each particular disc, and as such may be a serial identification. So for identically manufactured copies of the same movie, each copy is traceable by its unique serial identification. In one example, the serial identification is an alphanumeric code of a designated length (e.g., 16 alphanumeric characters). A portion of the code designates the movie name, while another portion of the code designates the retail store name, location, etc. The serial identification could be pre-registered prior to the consumer purchasing the particular disc or the serial identification could be registered at the point of sale. Regardless of the methodology, a database accessible by the playback device 215 stores the serial identification and the corresponding information including which retail store sold the particular copy of the disc. In one alternative, a barcode, stock-keeping unit (SKU) or any other type of coding system or set of identifiers could be used to correlate the product with the retail store, in addition or in lieu of the serial identification. In this example, a remote server receives the code and returns the retail store information to the playback device 215.

The playback device 215 includes a disc or content application 225, a network service application 230 and a service management application 235. The disc application 225 originates from the disc 220 and is stored in the memory (e.g., memory 145 of FIG. 1) of the playback device 215. That is, the disc application 225 is loaded to the playback device 215 at the initialization of the playback of the media content on the Blu-ray disc 220. In the Blu-ray context, the disc application 225 is a BD-J application authored with the movie contents on the Blu-ray disc 220. Alternatively, in place of reading and loading the disc application 225, the playback device 215 includes an embedded device application residing on the playback device 215. In this alternative implementation, the device application accesses the Blu-ray disc 220 to acquire retail store information and constructs the user interface to interact with the user.

The network service application 230 is an embedded application for playing digital contents from the network service and for displaying menu graphics to provide a user interface to the user. In this implementation, the network service application 230 is invoked when the playback device 215 is powered on. More particularly, when the playback device 215 is powered on, the network service application 230 registers an identifier of its network service to the service management application 235. In this manner, the disc application 225 determines which network services are available on the playback device 215 when it queries the service management application 235. The disc application 225 may also communicate with the network service application to retrieve information such as available titles, details related to the available titles, and to control playback.

The service management application 235 is an embedded application for keeping track of the available services on the playback device 215. The service management application 235 maintains a database matching available network services and its corresponding retail store. The service management application 235 provides information to the disc application 220 such as the priority rank of a particular network service and other related information.

As shown in FIG. 2, the playback device 215 communicates with a network service server 245 via the network 240. The network service server 245 stores digital content to be streamed to the user via the playback device 215. For example, upon a request from the disc application 225 or the service management application 235, related information about network services available and related contents is returned.

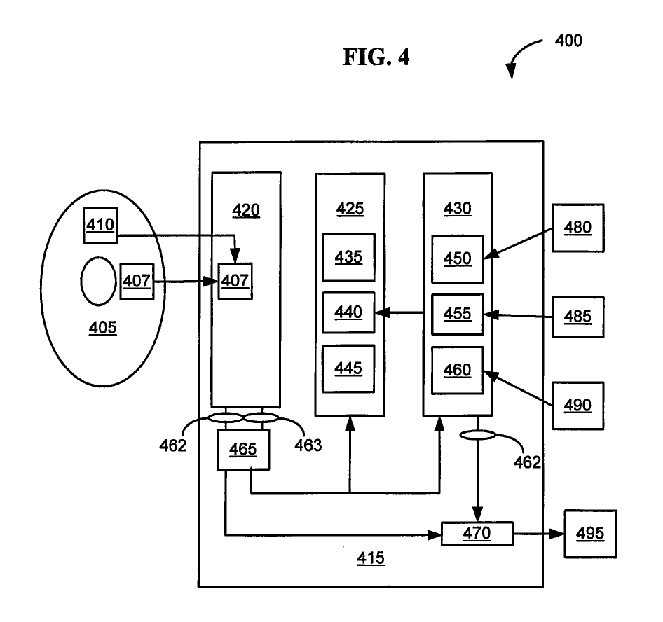

The basic structure of the system having been described, attention will now be turned to its operation. FIG. 3 is a flowchart illustrating one method of operation for the system illustrated in FIG. 4. In one implementation, the method illustrated in FIG. 3 describes the steps from initialization of the playback device to the receiving of a network service selection.

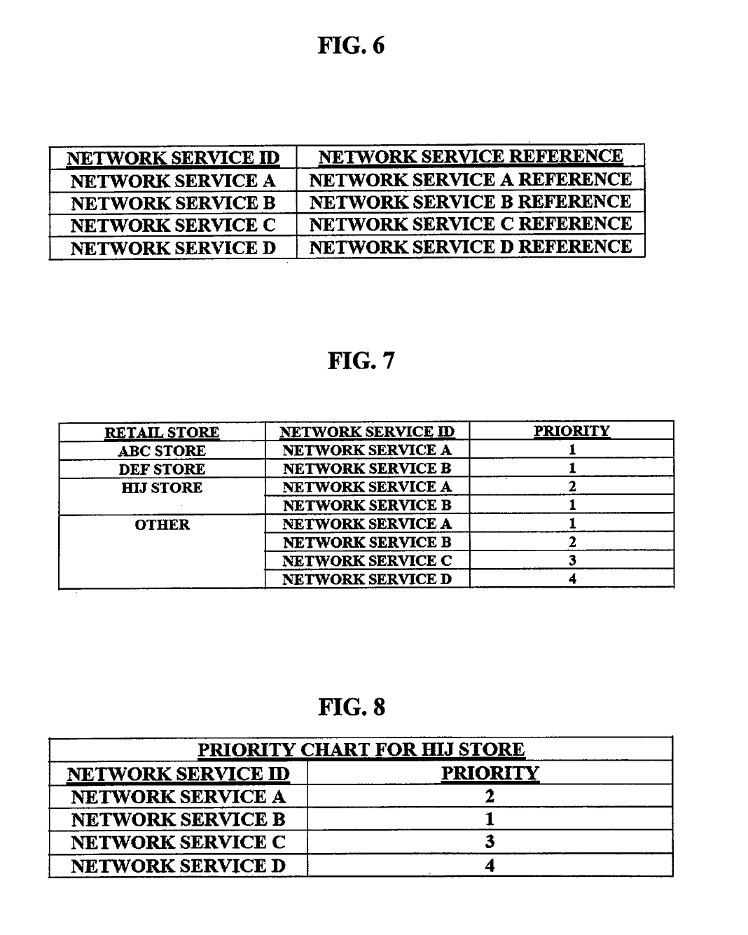

At step 305, the network service application 430 registers an identifier for each of its available network services 450, 455 and 460 with the network service registry 440 of the service management application 425. FIG. 6 illustrates an example of the data of the network service registry 440. As depicted, each of the four network service IDs registered has a corresponding reference. Each available network service 450, 455, 460 correlates with a different network service provider 480, 485 and 490, respectively. In one implementation, each retailer operates or is affiliated with one or more network service providers. For example, network service provider 480 is a proprietary service provider for an ABC store, network service provider 485 is a universal service provider affiliated with a number of different retail stores including the ABC store, a DEF store, a HIJ store and the like, and network service provider 490 is a proprietary service provider for the HIJ store. Additional service providers and corresponding network services are not shown for ease of understanding and clarity. The network services 450, 455 and 460 within the network service application 430 are the network services supported by the particular Blu-ray player 415. In other words, network services that are not supported by the particular playback device might not be registered to the service management application 425.

At step 310, the disc application 420 is loaded from the disc 405. For example, in the Blu-ray context, BD-J 407 is loaded onto a Java Virtual Machine (JVM). Furthermore, the retail store identifier 410 is also read into the disc application 420. It should be noted that retrieving the retail store identifier 410 from this disc 405 is most applicable to the situation where the retail store identifier 410 is stored on the disc media. However, one of ordinary still in the art will recognize that the retail store identifier may be retrieved and/or received from a number of different sources based on the format (e.g., streaming data, physical disc, etc.). In other words, depending on the format of how the content is received, the retail store identifier may be received by the playback device in the same manner as the content. Or, the retail store identifier may be received by the playback device in a different manner as the content.

At step 315, the disc application 225 is executed and the retail store identifier 410 is read. The retail store identifier 410 could be any type of indicia for identifying the retail store from which the Blu-ray disc 420 originated. The retail store identifier 410 is used however to determine the prioritization or ranking of the network services.

At step 320, the disc application 420 is authenticated by the authentication manager 435 of the service management application 425 via the network service application programming interface 463 through socket 465. Any of the authentication processes well known in the art may be utilized to authenticate the disc application 420.

After authentication, the disc application 420 now queries a list of available network services registered at the network service registry 440. More particularly, the disc application 420 queries the service management application 425 by passing the retail service identifier 410 at step 325.

In response, at step 330, the service management application 425 searches the retail store database 445 by using the identifiers registered at the network service registry 440 to obtain a list of available network services for the playback device 415. For example, as shown in FIG. 7, Network Service A is the available network service where the identifier corresponds to the ABC store, Network Service B is the available network service where the identifier corresponds to the DEF store, and both Network Service A and B are the available network services where the identifier corresponds to the HIJ store.

At step 335, the service management application 425 constructs a prioritized list of the available network services based on the retail store identifier and passes the list to the disc application 420. For instance, each of the available networks may be ranked based on a priority code associated with that network for that particular retail store.

At step 340, the disc application 420 displays the prioritized list to the user and receives user selection of one member of the prioritized list. While the list is prioritized and defaults to the highest ranked network service on the list, the user is allowed to select any of the network services on the list regardless of priority. However, by prioritizing the networks based on the retail store identifier, advantageously preference is initially given to the retail store from where the disc 405 was obtained. In this manner, the retail store that sold or provided the disc 405 has an advantage over non-affiliated network services, as it is prioritized over these other available network services. In one or more other implementations, the available networks that are not affiliated with the retail store are selectable only where the user proceeds through additional steps or manipulates through additional interface screens, thereby making it more convenient for the user to select the networks provided by the retail store. In another alternative implementation, the disc application 420 may select the highest prioritized member without user interaction. This implementation may be the most desirable to retail stores that sold or provided the disc 405. Or, if the user has set a hard-selection of a default network service, the default network service may be automatically selected by the disc application 420.

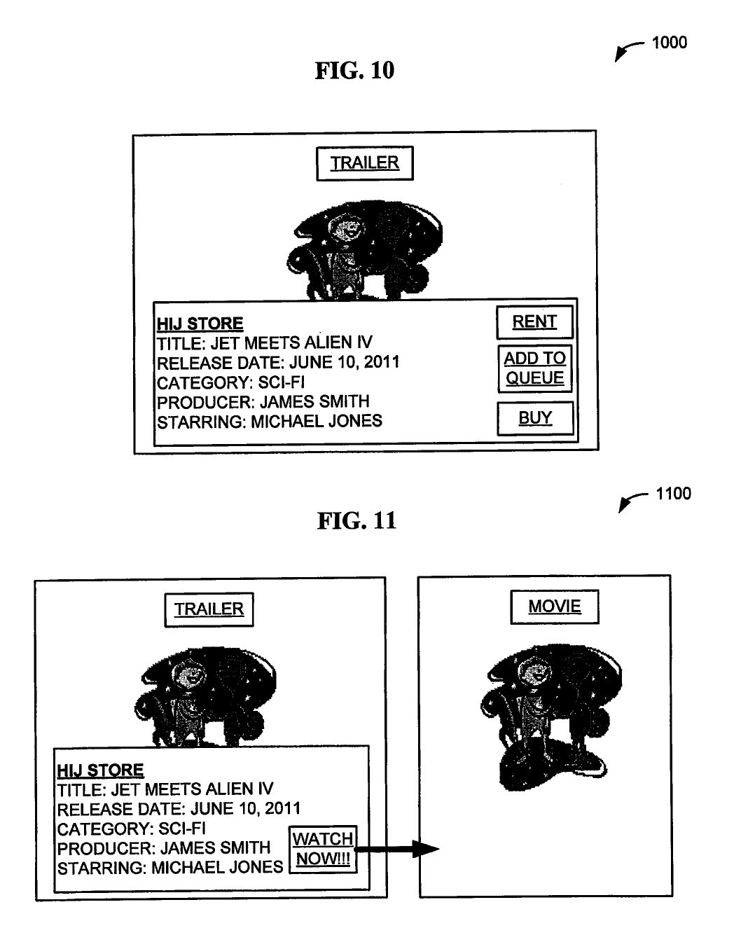

Subsequently, at step 345, the disc application 420 executes the network service selected by the user. In this manner, the chosen network service is based upon the retailer that sold the Blu-ray disc. Once the network service is selected, the advertisement, trailer, etc. displayed to the user is configured by the network service provider. FIGS. 10 and 11, further described below are examples of content provided by the network service provider. In one implementation, after the user exits the content, the user is brought to the menu page of the feature film.

As shown in FIG. 4, the playback device 415, and more particularly the network service application 430 has the further capability of making a digital copy 470 on a memory device 495 via the digital copy application programming interface 462. For example, the digital copy 470 is a trailer provided by the network service selected by the user, a movie or clip selected by the user or a copy of media that is displayed to the user during the playback session.

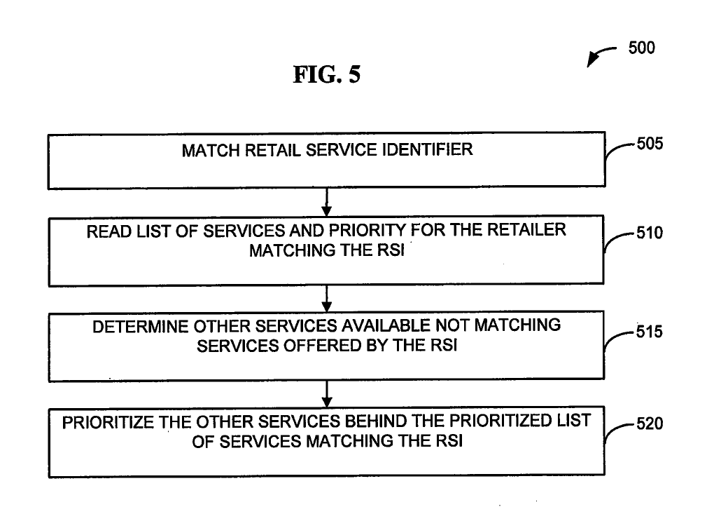

FIG. 5 illustrates a flowchart 500 of a method of ordering or prioritizing the available network services. At step 505, the retail service identifier is matched to determine which network service list is applicable for the particular retail store identified. As shown in the example illustrated in FIG. 7, each store has its own corresponding network services, prioritized for the particular store. For example, the ABC store has only one network service (network service A) and thus that particular network service has the highest rank of 1. For the DEF store, similarly only one network service (network service B) is present, and thus that particular network service has the highest rank of 1. For the HIJ store, two network services (network service A and network service B) are present, and are prioritized with network service B ranking higher (given a rank of 1) than network service A (given a rank of 2). The “Other” category may correspond to all the network services available on the playback device regardless of its affiliation with a retail store.

Referring back to the flowchart 500, at step 510, the list of services and priority for the retailer matching the retailer store identifier is read. FIG. 8 illustrates an example of a resulting priority chart for the HIJ store. As depicted, for the HIJ store, network service B ranked 1 and network service A ranked 2 is read where the retailer store identifier matches or corresponds to the HIJ store.

At step 515, other network services not matching the services offered by the HIJ are determined. Therefore, with respect to the HIJ store as illustrated in FIG. 8, network services C and D are determined at this step.

At step 520, the other network services are prioritized behind the prioritized list matching the retailer store identifier. As referenced in FIG. 7, the HIJ store ranks network service B first, then network service A second. However, the other network services available on the playback device not yet ranked are appended and prioritized in the order given by the “Other” category. As such, network service C is given a rank of 3 and network service D is given a rank of 4. These ranking numbers determine the order the network services A-D are shown to the user on the display.

This novel prioritization system illustrated in FIG. 5 enables linking the retail store with the network services on a Blu-ray platform. The retail store is able to thus establish a sales channel directly with the user that purchased the disc 220 from the retail store (here, in this example, the HIJ store).

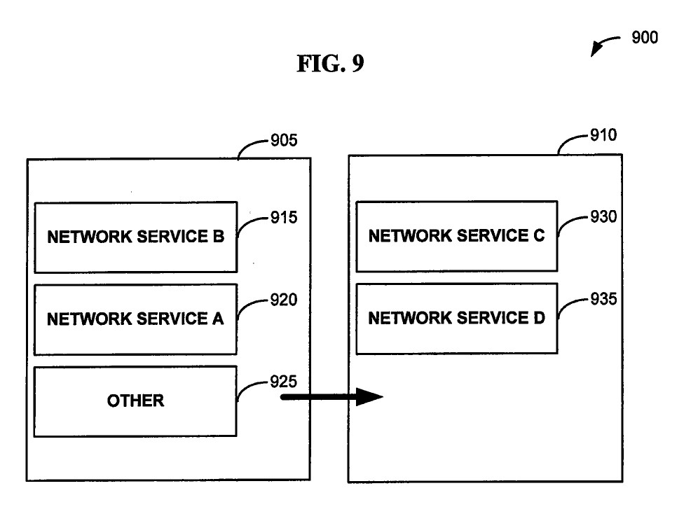

FIG. 9 illustrates examples of screen shots 905 and 910 of a dynamic menu displayable to the user as presented by the disc application (e.g., disc application 225 or 420). The dynamic menu displayed corresponds to the scenario where the HIJ store is identified as the retailer providing the disc 220. Here, the selectable icons network service B 915, network service A 920 and other 925 are displayed to the user in a first screen 905. Network service B 915 is listed at the top of the menu and is a default selection when the menu is first presented to the user since it has the highest priority rank of 1 for the HIJ store as shown in the chart of FIG. 7. Next, network service A 920 is listed as the second option presented to the user since it has the second highest priority rank of 2 for the HIJ store. Should the user desire to select a network service other than network service B or network service A, the user may select the “Other” icon 925. In response to the user selecting “Other”, second screen 910 is displayed to the user providing the third-ranked network service C 930 and the fourth-ranked network service D 935. In this manner, the network services B and A corresponding to the retail store where the disc was purchased is shown first, however, other network services available on the playback device corresponding to other retail stores is also displayed, albeit in an intentionally lesser convenient manner. In one alternative, instead of a button or icon, a dedicated portion of the viewable graphical area of a display screen is controlled by the network service application to determine what is to be shown. For example, the disc application draws or provides frames, while the network service application fills the graphical content within each frame. In another alternative, the prioritized list is displayed from left to right, designated with different colors, shapes, fonts, layers, etc. Other implementations are possible, for example, where only the network service with priority ranking of 1 is shown to the user on the display.

FIG. 10 illustrates a screenshot of a trailer, for example, after a network service (e.g., network service B) has been selected. Here, the trailer is for a different movie which might have a relation to the content of the disc (e.g., same genre, same actor, same director, movies of the same series, etc.). For example, where the content of the disc is a science fiction movie titled JET MEETS ALIEN V, the movie of the trailer is for JET MEETS ALIEN IV, the prequel to the movie already purchased. In this manner, the user is invited to rent, purchase or add the movie of the trailer to a queue or “shopping cart”. More generally, the present invention provides a seamless transition from the disc content to the network service. As shown in FIG. 11, a “WATCH NOW!! !” button allows the user to start watching the movie of the trailer seamlessly right from the disc content without ever stopping the disc and launching the network service application manually. In this particular example, the user who might have missed the prequel to the movie of the disc content is now able to watch the preceding movies in the series prior to or after the movie on the disc without having to perform a cumbersome and/or lesser convenient errand (e.g., going to the store to rent the movie, going online and searching for the movie and then streaming the movie, etc.).

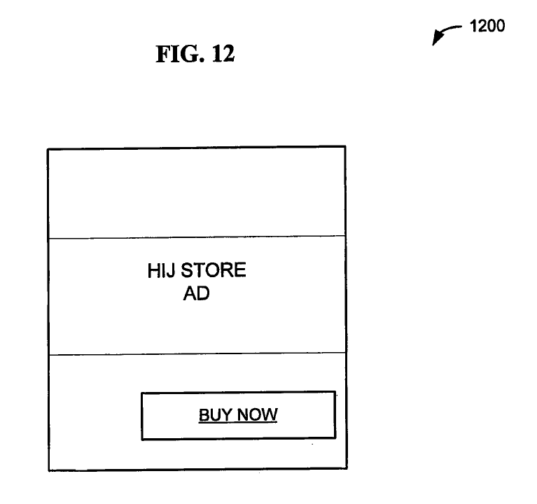

In one implementation, the user is able to purchase or rent more than just a movie or streaming media. As shown in FIG. 12, in addition to or instead of the trailers of FIG. 10 and/or FIG. 11, an advertisement related to the selected network service is possible via a dynamically inserted advertisement. Based at least in part on the retail store where the disc was bought, that particular retailer is able to promote itself, its products and/or available content on the network service. For instance, where the user selects the “BUY NOW” button or icon, the user is prompted to enter in credit card information or confirm using the credit card information stored in their Blu-ray/network player to purchase the product. Alternatively, the user could be taken to a log-in screen particular to the network service where the user is invited to purchase the item using their account on the network service.

In one implementation, the playback device is able to track movies watched, the movies purchased, rented, etc. The tracked information may be provided to the network service provider when the particular network service provider is selected. The tracked information is useful to the network service provider to determine which trailer to provide to the user. For example, the network service provider might not want to show a trailer for a movie that the user has already purchased or watched.

Certain basic implementations having been discussed including the implementation for a Blu-ray playback device, attention will be turned to variations within the scope of the present invention. The following should not be construed as limiting but are merely examples to further illustrate the points discussed herein.

With respect to the retail store information, as discussed herein, this information is read from the disc. However, the retail store information could be obtained in any of a plurality of other methods. For example, a user could input the retail store information with a remote, keyboard, mouse, voice-control, eye-gesture, etc. In another example, the retail store information is obtained via a memory card inserted into the playback device. Where the content is not provided on a disc, but instead is purchased from a network, the retail store information might be received or streamed from the network site providing the disc. The retail store information could also be substituted with another code such as a digital copy activation code transmitted through the Internet the first time the disc is played by the playback device. For example, with respect to a Blu-ray's “digital copy” feature, the digital copy includes serial identification information which could be used to determine the retailer that provided or sold the Blu-ray disc.

In one implementation, the serial identification information or code is transmitted to a remote server over the network, which then identifies the retail store from the received data using its own database, and returns the retail store information back to the playback device.

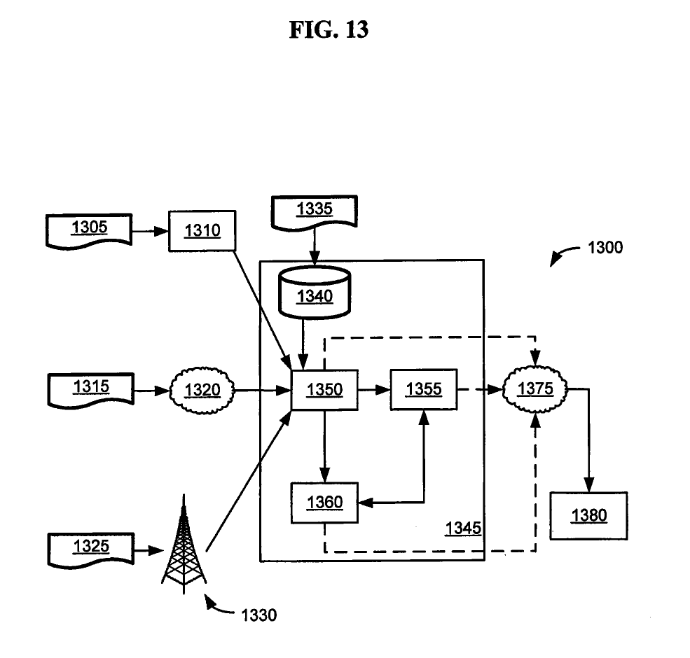

With respect to content, it can be purchased in any form. For example, the content is purchasable on any storage device not limited to discs, such as flash memory sticks and the like. In addition, the content is purchasable and downloaded as a digital format over the Internet or network provider. Or, the content is purchasable as digital format over a broadcasting signal. The content may further be purchasable via electronic sell-through (EST), manufactured-on-demand (MOD), streaming content, or from a kiosk. However, in certain cases, if not most, playback of digital media may further be constrained by copyright protection, and the copyright protection is usually proprietarily tied to the specific service. Should a “buy once, watch anywhere” service be established, a user may be able to purchase content from one retailer and play it on many playback devices in the same manner as contents purchased from other retailers (e.g., as the digital media is distributed via network, broadcast, etc.). FIG. 13 illustrates a system where the content is of different forms and from different sources. As shown, the content playback device 1345 includes a device application 1350 configured to play content of one or more different formats. For example, content 1305 is provided to the device application via a SD card 1310, content 1315 is streamed from the network 1320, content 1325 is broadcasted through tower 1330 and content 1335 is obtained and stored in media storage 1340. As illustrated, the content 1305, 1315, 1325 and 1335 are obtained or purchased from any of a number of different sources including a retail store, a distributor, copyright holders, licensors, etc. In addition to the content, the device application 1350 receives identification of the source of the content.

In one implementation, as similarly explained with respect to FIG. 2, the network service application 1355 of FIG. 13 is an embedded application for playing digital contents from the network service and for displaying menu graphics to provide a user interface to the user. In this implementation, the network service application 1355 is invoked when the playback device 1345 is powered on. More particularly, when the playback device 1345 is powered on, the network service application 1355 registers an identifier of its network service to the service management application 1360. In this manner, the device application 1350 realizes which network services are available on the playback device 1345 when it queries the service management application 1360. The device application 1350 can also communicate with the network service application 1355 to retrieve information such as available titles, details related to the available titles, and to control playback.

The service management application 1360 is an embedded application for keeping track of the available services on the playback device 1345. The service management application 1360 maintains a database matching available network services and its corresponding source. The service management application 1360 provides information to the device application 1350 such as the priority rank of a particular network service and other related information. In addition, the service management application 1360 manages hardware resources such as the processor, memory, network controller, encoders, decoders, graphical interfaces, input/output interface and related devices. The service management application 1360 also provides synchronization, access control, inter-communication methods and the like. While not shown, the retail store database might be stored locally at the service management application 1360. Alternatively, the retail store database or a retail store database server remote to the playback device 1345 might be accessed by the playback device 1345 whenever retail store information is needed.

As shown in FIG. 13, the playback device 1345 communicates with a network service server 1380 via the network 1375. The network service server 1380 could store digital content to be streamed to the user via the playback device 1345. For example, upon a request from the device application 1350 or the service management application 1360, related information about network services available and related contents are returned.

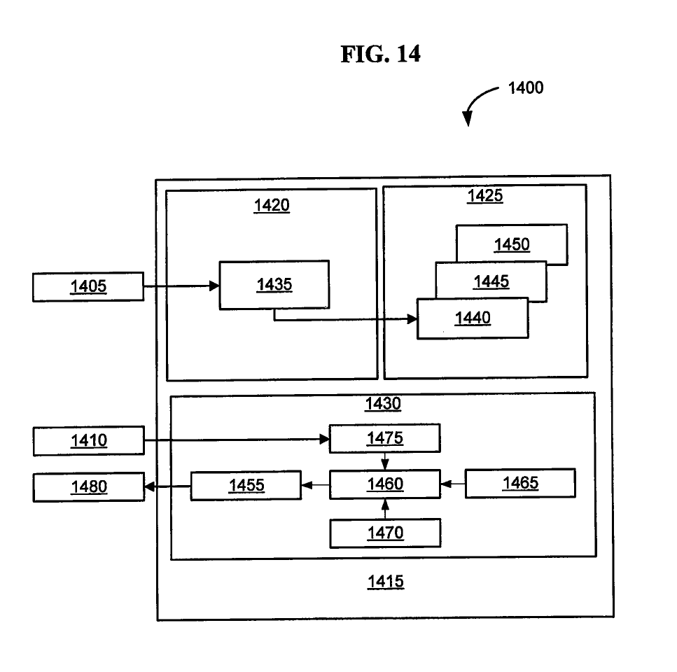

FIG. 14 illustrates one implementation of a playback system 1400 including inputs 1405 and 1410, the playback device 1415 and an output 1480. Certain other portions of the system 1400 such as the network connections and content providing servers for network services have been omitted for clarity. In one implementation, the playback device 1415 might not be a dedicated Blu-ray player as shown in FIG. 4. For instance, the playback device 1415 may be a set-top box, a streaming audio-video machine, a video game console, a computer enabled to communicate with the network service provider, a hand-held mobile communication device, a software player, a home appliance, e-move reader, a photo frame, a camera, any consumer electronics device, and the like. In other words, the playback device 1415 may be any software or hardware system that plays or presents contents described herein (e.g., audio content, video content, still picture or image content, text, and any combination thereof). However, the playback device 1415 could also incorporate similar features as those discussed above with respect to FIG. 4.

As shown, the playback device 1415 includes a content application 1420, a network service application 1425 and a service management application 1430. The service management application 1430 includes a retail store identification module 1475, a priority allocation module 1460, a network service registry 1465 and a display module 1455. The retail identification module 1475 reads in a retail identifier (e.g., an alphanumeric code, a store name, a store location, etc.) from a retail store information source 1410 and determines the identity of the retail store associated with the content.

The priority allocation module 1460 receives the retail store identity information and further obtains the available network service list from the network service registry 1465 and cross references the identity information and the available network service list with the priority ranking information located in the retail store database 1470 to construct a priority listing of all the available network services. The priority listing is then provided to the display module 1455 for displaying to the user. Once displayed to the user, the content application 1420 receives user input 1405 via an interface module 1435 for selecting a network service among the prioritized listing of the available network services (e.g., network service 1440, 1445 or 1450) of the network service application 1425. In this manner, the playback device 1415 builds a customized, prioritized network service availability list based on the retail identifier and the available network services supported by the playback device.

So, for example, where the playback device only supports network services A, B, C, D and E and where the retail store identified may provide network services A, B, F and G prioritized in this order, the availability list constructed by the priority allocation module 1460 might only include network services A and B ranked in that order for the retail store. As network services F and G are not supported by the playback device 1415, the priority allocation module 1460 prevents these selections from being displayed to the user in order to avoid confusing the user. Alternatively, these selections are displayed but “greyed out” or otherwise not available for selection. In one implementation, the other network services C, D and E are displayed to the user at a lower priority rank. Alternatively, these options are prevented from being displayed as they are not associated with the retail store identified as supplying the content. In this manner, regardless of the media type (disc, flash memory, streaming media, cartridge, etc.) the concept of prioritizing and ranking available network services is still applicable.

In one variation of the implementation of the priority ranking methodology, the retail store where the playback device (and not the retail store where the disc was bought) is ranked as the highest, followed by the retail store where the disc or play media was bought (if different). Under this variation, the serial identification of the playback device to uniquely identify the retail store may be stored or hard-coded in the memory of the playback device. Or, the identification data may be a stock-keeping unit (SKU) or other code transmitted to a remote server to obtain retail store information of the playback device.

In another implementation, the present invention may be a Blu-ray player, a set-top box, or another consumer electronic device that has a serial identification or code associated with the particular device. In this manner, the serial identification or code may associate the electronic device with the retailer from which the device was purchased from. For example, the retail store identified may have priority over retail stores associated with content purchased (e.g., Blu-ray discs, streaming media, etc.) when the prioritized list is determined. Other variations include allowing the user to select a default retailer that is always ranked the highest, followed by where the playback device was bought and then the retail store where the disc or play media was bought. Furthermore, instead of sorting by priority, other attributes such as availability, price, or a loyalty program that the customer belongs to may be used. Or, even where a list is sorted by priority, the list may be then filtered by one or more of these conditions.

In another implementation, the service management module may be omitted. For example, with respect to a multi-application process platform, the service management module might not be required because the content could broadcast the query and ask each network service application for its availability.

However, the present invention might not be limited to electronic devices. For instance, a paper-book may be purchased from a bookstore having a unique serial identification code, and upon the user entering the code in an electronic device, the retail store information may be determined from the serial identification code and content related to that retail store may be provided to the user in the manner as described herein. As this example illustrates, content as discussed herein may, in one aspect, broadly include any product that is obtainable and in some manner identifies the retailer.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A playback apparatus comprising:
a processor;
a network controller coupled to the processor for sending and receiving data to at least one network service provider;
an input/output interface coupled to the processor for receiving input from a user and for transmitting data to be displayed to the user; and
a memory storing instructions that when executed by the processor causes the processor to perform:
reading content from a content provider, the content including playback media and a retail identification code,
determining a prioritized list of network services based on the retail identification code,
transmitting the prioritized list of the network services via the input/output interface to a display device,
receiving a selection of a network service from the prioritized list from a user via the input/output interface,
transmitting a request for content from a network service provider corresponding to the network service via the network controller,
receiving the requested content from the network service provider via the network controller, and
transmitting the received requested content to the display device via the input/output interface.

2. The playback apparatus of claim 1, wherein the playback apparatus is a Blu-ray player.

3. The playback apparatus of claim 2, wherein the content from the content provider is a Blu-ray disc.

4. The playback apparatus of claim 1, wherein the playback apparatus is one of a set-top box, a streaming audio or video machine, a video game console, a computer enabled to communicate with the network service provider, a hand-held mobile communication device, a software player, a home appliance, e-move reader, a photo frame, or a camera.

5. The playback apparatus of claim 4, wherein the content from the content provider is in the format of one of: a storage media, a broadcast signal, streaming data, or downloaded data.

6. The playback apparatus of claim 1, wherein determining the prioritized list of network services based on the retail identification code further includes:
matching the retail identification code with a retail store;
reading a list of network services corresponding to the retail store and a corresponding priority rank; and
ordering the list of network services corresponding to the retail store based on the priority rank.

7. The playback apparatus of claim 6, wherein determining the prioritized list of network services based on the retail identification code further includes:
determining a list of network services and a corresponding priority rank for network services supported by the playback apparatus and not corresponding to the retail store;
ordering the list of network services supported by the playback apparatus and not corresponding to the retail store based on the priority rank of the network services supported by the playback apparatus and not corresponding to the retail store; and
constructing an overall list of the network services with a lowest ranked network service corresponding to the retail store being ranked higher than the highest ranked network services supported by the playback apparatus and not corresponding to the retail store.

8. The playback apparatus of claim 1, wherein received requested content is a movie trailer including an interface for receiving user input to obtain the entire movie from the network service provider.

9. The playback apparatus of claim 8, wherein the memory further storing instructions that when executed by the processor causes the processor to perform:
receiving user input to obtain the entire movie from the network service provider;
obtaining the entire movie from the network service provider; and
transmitting the entire movie to a display device for displaying to the user.

10. The playback apparatus of claim 9, wherein the entire movie is displayed to the user prior to playing the contents provided by the content provider.

11. The playback apparatus of claim 9, wherein user input to obtain the entire movie is user input corresponding to purchasing the movie.

12. The playback apparatus of claim 9, wherein user input to obtain the entire movie is user input corresponding to renting the movie.

13. The playback apparatus of claim 9, wherein user input to obtain the entire movie is user input corresponding to adding the movie to a queue.

14. The playback apparatus of claim 1, wherein received requested content is an advertisement including an interface for receiving user input to obtain the product or service being advertised.

15. The playback apparatus of claim 14, wherein the advertisement corresponds to one of: text content, audio content, image content or video content.

16. The playback apparatus of claim 15, wherein the product or service being advertised is provided to the user prior to playing the contents provided by the content provider.

17. The playback apparatus of claim 15, wherein user input to obtain the product or service being advertised is user input corresponding to purchasing the product or service.

18. The playback apparatus of claim 15, wherein user input to obtain the product or service being advertised is user input corresponding to renting the product or service.

19. The playback apparatus of claim 15, wherein user input to obtain the product or service is user input corresponding to adding the product or service to a queue.

20. A system comprising:
playback media storing playback content and an identifier indicating a retail source of the playback media;
a playback media player having one or more network service capabilities, the playback media player configured to read the playback media to playback the playback content, and to determine a priority ranking of the one or more network service capabilities based on the retail source of the playback media; and
one or more network service providing servers corresponding to the one or more network service capabilities of the playback media player, the one or more network service providing servers each configured to send playback content different than the playback content on the playback media playable on the playback media player.

21. The system of claim 20, wherein the playback media player includes an embedded network service application and service management application, and is further configured to load a content application from the playback media.

22. The system of claim 21, wherein the network service application is configured to register the one or more network service capabilities with the service management application.

23. The system of claim 22, wherein the content application is configured to provide the identifier indicating the retail source of the playback media to the service management application.

24. The system of claim 23, wherein the service management application is configured to determine the priority ranking of the one or more network service capabilities based on the retail source of the playback media.

25. A non-transitory computer readable medium storing instructions that when executed by a processor, causes the processor to perform the method comprising:
reading content from a content provider, the content including playback media and a retail identification code;
determining a prioritized list of network services based on the retail identification code;
transmitting the prioritized list of the network services to a display device;
receiving a selection of a network service from the prioritized list from a user;
transmitting a request for content from a network service provider corresponding to the network service;
receiving the requested content from the network service provider; and
transmitting the received requested content to the display device.

26. The computer-readable medium of claim 25, wherein determining the prioritized list of network services based on the retail identification code further includes:
matching the retail identification code with a retail store;
reading a list of network services corresponding to the retail store and a corresponding priority rank; and
ordering the list of network services corresponding to the retail store based on the priority rank.

27. The computer-readable medium of claim 26, wherein determining the prioritized list of network services based on the retail identification code further includes:
determining a list of network services and a corresponding priority rank for network services supported by a playback apparatus and not corresponding to the retail store;
ordering the list of network services supported by the playback apparatus and not corresponding to the retail store based on the priority rank of the network services supported by the playback apparatus and not corresponding to the retail store; and
constructing an overall list of the network services with a lowest ranked network service corresponding to the retail store being ranked higher than the highest ranked network services supported by the playback apparatus and not corresponding to the retail store.

28. A method comprising:
receiving a retail identification code;
determining, at the media playback device, a prioritized list of network services based on the retail identification code;
selecting a network service with from the prioritized list of network services based on the retail identification code;
transmitting from the playback device a request for content to a network service provider corresponding to the network service;
receiving the requested content from the network service provider at the playback device; and
transmitting the received requested content from the playback device to the display device.

29. The method of claim 28 further including:
matching the retail identification code with a retail store;
reading a list of network services corresponding to the retail store and a corresponding priority rank; and
ordering the list of network services corresponding to the retail store based on the priority rank.

30. The method of claim 29 further including reading content from a content provider at a media playback device, the content including playback media and the retail identification code.

31. The method of claim 30 further including:
transmitting the prioritized list of the network services from the media playback device to a display device; and
receiving a selection of a network service at the playback device from the prioritized list from a user.
